(19) United States
(12) Patent Application Publication
(10) Pub. No.: US 2012/0240337 A1
(43) Pub. Date: Sep. 27, 2012

(54) TWO-STAGE ACTUATING DEVICE FOR ELECTRIC APPARATUS

(75) Inventor: Lung-Tan SHIH, Changhua County (TW)

(73) Assignee: RUOEY LUNG ENTERPRISE CORP., Changhua County (TW)

(21) Appl. No.: 13/490,121

(22) Filed: Jun. 6, 2012

Related U.S. Application Data
(63) Continuation-in-part of application No. 12/607,975, filed on Oct. 28, 2009, now Pat. No. 8,209,800.

(51) Int. Cl. A61G 7/018

(52) U.S. Cl. 5/616

(57) ABSTRACT

A two-stage actuating device for an electric apparatus includes a driver mounted to a fixing frame of the electric apparatus and provided with a retractable rod, a link rod having one end pivotally connected with the retractable rod of the driver and the other end pivotally connected with a moveable frame of the electric apparatus, and a bracket having one end mounted to the moveable frame and the other end connected with the retractable rod in such a way that the link rod is pushed by the retractable rod within a first-stage stroke of the retable rod to drive a first-stage movement of the moveable frame, and then the bracket is pushed by the retractable rod in a second-stage stroke of the retractable rod to drive a second-stage movement of the moveable frame.

### CROSS-REFERENCE TO RELATED APPLICATIONS

This application is a continuation-in-part of U.S. application Ser. No. 12/607,975, filed on Oct. 28, 2009.

### BACKGROUND OF THE INVENTION

1. Field of the Invention

The present invention relates generally to an electric apparatus, and more specifically to an actuating device for an electric apparatus, which enables the electric apparatus to perform a two-stage movement.

2. Description of the Related Art

Currently, most bed frames are designed for a user to lay flat while sleeping, and a typical bed frame includes four legs and supports. However, due to the stresses of modern life, many people suffer from insomnia and therefore suffer from a lack of sufficient rest. Consequently, many bed frames have included additional features, such as providing electrical head or leg lifting capabilities, and the user can select and adjust proper positions for him or herself. In the prior art, an electromechanical bed frame includes an upper portion frame, a fixed portion frame, and a lower portion frame. When the user wants to lift his or her head higher, the upper portion frame pivots around a connection region between the upper portion frame and the fixed portion frame to lift the other end of the upper portion frame; if the user wants to lift his or her lower legs higher, the lower portion frame pivots around the connection area between the lower portion frame and the fixed portion frame to lift the other end of the lower portion frame. However, the prior art bed structure can only lift one area at a time, which may be uncomfortable for the user.

### SUMMARY OF THE INVENTION

The present invention has been accomplished in view of the above-noted circumstances. It is therefore one objective of the present invention to provide a two-stage actuating device for an electric apparatus, which can be used to drive a moveable frame of the electric apparatus to perform a two-stage movement so as to enhance a user's comfort.

To achieve this objective of the present invention, the two-stage actuating device comprises a driver having a cylinder body pivotally mounted to a fixing frame of the electric apparatus, and a retractable rod extending out of the cylinder body, a link rod having one end pivotally connected with the retractable rod of the driver through a pivot and the other end pivotally connected with the moveable frame of the electric apparatus, a bracket mounted to the moveable frame, and two-stage actuating means for connecting the bracket with the retractable rod of the driver for allowing the bracket not to be driven by the retractable rod and the link rod to be driven by the retractable rod to move to cause a first-stage movement of the moveable frame relative to the fixing frame when the retractable rod extends within a predetermined distance, and allowing the link rod and the bracket to be driven by the retractable rod to move to cause a second-stage movement of the moveable frame relative to the fixing frame when the retractable rod extends exceeding the predetermined distance.

By this way, during the first-stage stroke of the retractable rod of the driver, the link rod can be pushed by the retractable rod to drive the moveable frame to perform a first-stage pivotal or folding movement, and then, in a second-stage stroke of the retractable rod, the bracket can be pushed by the retractable rod to drive the moveable frame to perform a second-stage pivotal or folding movement.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic drawing of an electric apparatus equipped with a two-stage actuating device according to the first embodiment of the present invention;

FIG. 2 is an enlarged view of a part of FIG. 1, showing the two-stage actuating device of the first embodiment of the present invention isn't started;

FIG. 3 is similar to FIG. 1, but showing the third structural component of the moveable frame is lifted;

FIG. 4 is similar to FIG. 2, but showing the two-stage actuating device is operated in the first stage;

FIG. 5 is similar to FIG. 3, but showing the second structural component of the moveable frame is lifted;

FIG. 6 is similar to FIG. 4, but showing the two-stage actuating device according to the first embodiment of the present invention is operated is the second stage;

FIG. 7 is another schematic drawing of the electric apparatus, showing the two-stage actuating device according to the first embodiment of the present invention is installed in a contrary direction;

FIG. 8 is similar to FIG. 7, but showing the third structural component of the moveable frame is lifted;

FIG. 9 is a schematic drawing of the electric apparatus equipped with the two-stage actuating device according to a second embodiment of the present invention;

FIG. 10 is an enlarged view of a part of FIG. 9, showing the two-stage actuating device according to the second embodiment of the present invention isn't started;

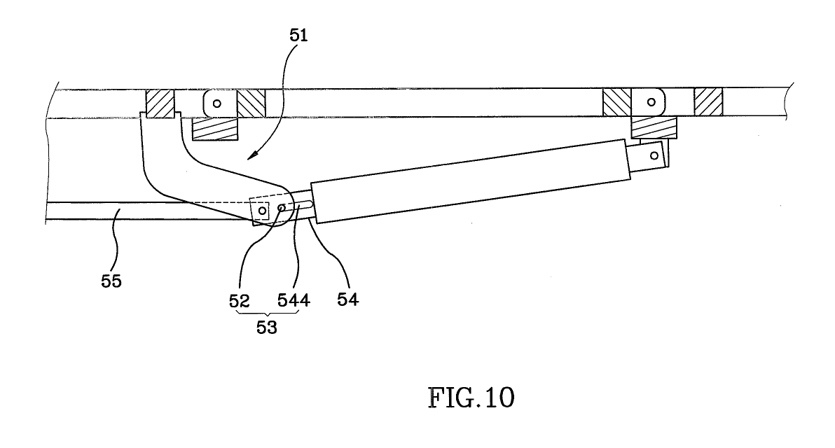

FIG. 11 is similar to FIG. 10, but showing the two-stage actuating device according to the second embodiment of the present invention is operated in the first stage;

FIG. 12 is similar to FIG. 9, but showing the third structural component of the moveable frame is lifted;

FIG. 13 is similar to FIG. 12, but showing the second structural component of the moveable frame is lifted;

FIG. 14 is an enlarge view of FIG. 13, showing the two-stage actuating device of the second embodiment of the present invention is operated in the second stage;

FIG. 15 is another schematic drawing of the electric apparatus, showing the two-stage actuating device according to the second embodiment of the present invention is installed in a contrary direction; and

FIG. 16 is similar to FIG. 15, but showing the second and third structural components of the moveable frame are lifted.

### DETAILED DESCRIPTION OF THE INVENTION

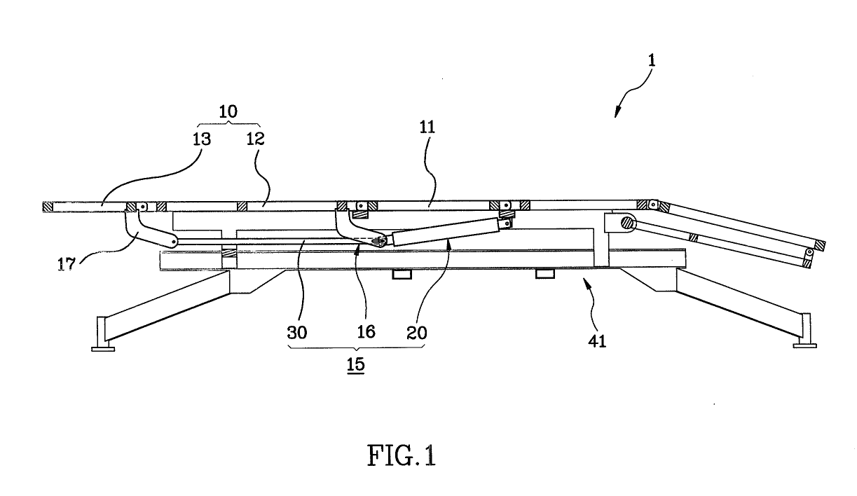

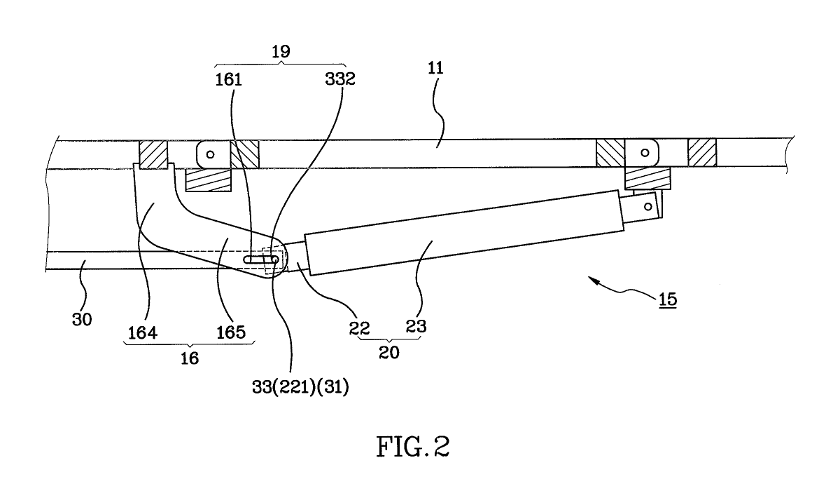

Firstly, it is to be understood that an electric apparatus that can be equipped with a two-stage actuating device of the present invention can be, but not limited to, an electric bed, an electric chair or the like. FIG. 1 shows an electric apparatus 1, which is realized as an electric bed according to a first embodiment of the present invention. The electric apparatus 1 comprises a fixing frame 41 and a moveable frame 10. The fixing frame 41 has a first structural component 11 that may be configured to be moveable or immoveable relative to the base of the fixing frame 41. The moveable frame 10 has a second structural component 12 and a third structural component 13. The second structural component 12 is pivotally connected at the two sides thereof between the first and third structural components 11 and 13. As shown in FIG. 2, a two-stage actuating device 15 in accordance with a first embodiment of the present invention comprises a driver 20, a link rod 30, two first brackets 16, and two-stage actuating means 19.

Any linear actuator, such as an electric motor-powered actuator, a pneumatic actuator or a hydraulic actuator, can be used as the driver 20 of the present invention. In this embodiment, the driver 20 includes a cylinder body 23 and a retractable rod 22. The cylinder body 23 has one end pivotally connected with the first structural component 11 of the fixing frame 41, and the retractable rod 22 extends out of the other end of the cylinder body 23 and has a through hole 221 at the distal end thereof.

The link rod 30 has one end located at between two second brackets 17 and pivotally connected with the bottom ends of the second brackets 17. The second brackets 17 each have a top end fixed to the third structural component 13 of the moveable frame 10, such that the link rod 30 is pivotally connected with the third structural component 13 of the moveable frame 10 through the second brackets 17. Further, the other end of the link rod 30 has an aperture 31 aligned with the through hole 221 of the retractable rod 22. A pivot 33 is inserted through the aperture 31 and the through hole 221, such that the link rod 30 is pivotally connected with the retractable rod 22 of the driver 20. To deserve to be mentioned, the electric apparatus 1 can be provided with only one second bracket 17, which can achieve the same effect that the two second brackets 17 disclosed in this embodiment can provide.

The first brackets 16 are arranged in a parallel manner with a space therebetween for insertion of the retractable rod 22 and the link rod 30. Each first bracket has an upright portion 164 with a top end mounted with the second structural component 12 of the movable frame 10, and a traverse portion 165 transversely extending from the bottom end of the upright portion 164.

The two-stage actuating means 19 is adapted for connecting the transverse portions 165 of the first brackets 16 with the retractable rod 22 for allowing the link rod 30 to be driven by the retractable rod 22 to move and the first brackets 16 not to be driven by the retractable rod 22 to cause a first-stage pivotal movement of the moveable frame 10 relative to the fixing frame 41 when the retractable rod 22 extends within a predetermined distance, and allowing the link rod 30 and the first brackets 16 to be driven by the retractable rod 22 to move to cause a second stage pivotal movement of the moveable frame 10 relative to the fixing frame 41 when the retractable rod 22 extends exceeding the predetermined distance. In this embodiment, the two-stage actuating means 19 comprises two sliding slots 161 respectively provided at the traverse portions 165 of the first brackets 16, and two extending members 332 respectively extending outwards from two ends of the pivot 33 along the axial direction of the pivot 33 and movably inserted into the sliding slots 161. It will be appreciated that the two-stage actuating device 15 can provide only one first bracket 16, and in this case, the two-stage actuating means 19 may comprise only one extending member 332 inserted into one sliding slot 161 provided at the sole first bracket 16.

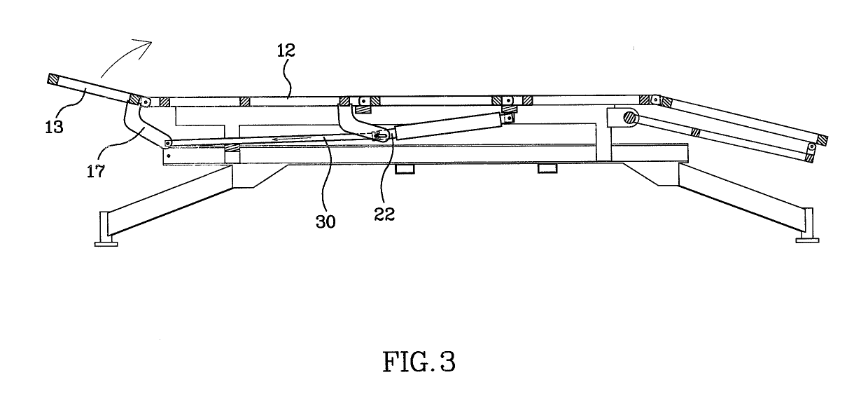

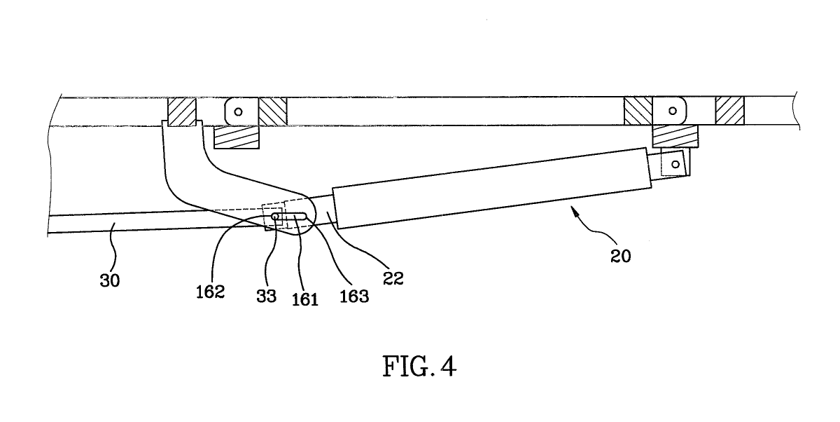

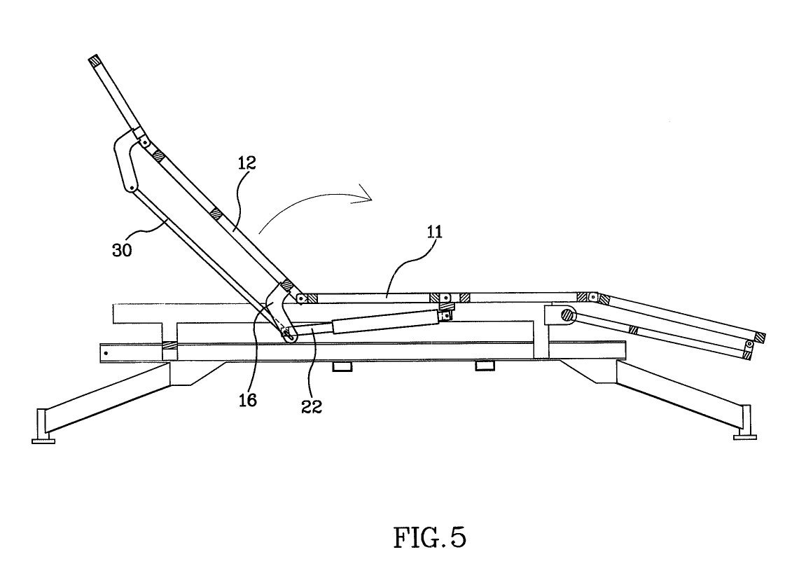

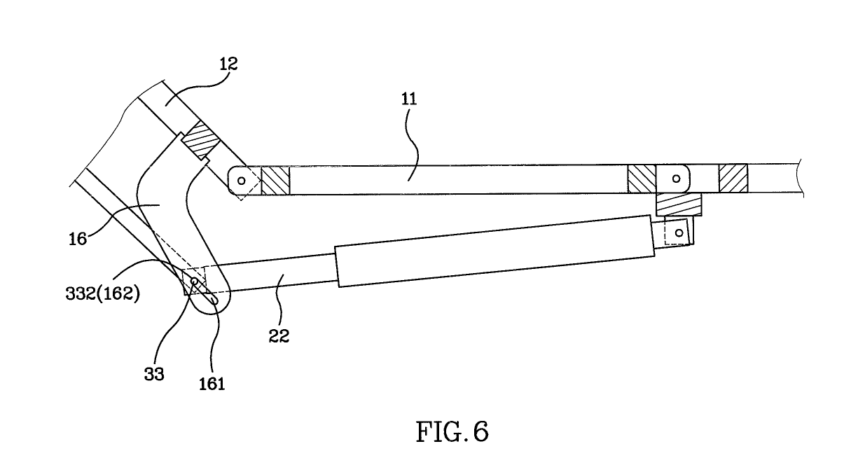

As shown in FIG. 4, when the retractable rod 22 of the driver 20 extends within a predetermined distance, the pivot 33 is pushed by the retractable rod 22 to move from the rear ends 163 toward the front ends 162 of the sliding slots 161. During the movement of the pivot 33, the link rod 30 is driven by the pivot 33 to push the second brackets 17, such that the second brackets 17 are forced to lift the third structural component 13 of the moveable frame 10, as shown in FIG. 3. At this stage, the first brackets 16 won't be pushed by the retractable rod 22, and therefore the second structural component 12 is stayed stationarily. Once the retractable rod 22 extends exceeding the predetermined distance, the extending members 332 will reach and urge against the front ends 162 of the sliding slots 161, as shown in FIG. 6, such that the retractable rod 22 will push the first brackets 16 through the extending members 332. At this stage, the second structural component 12 is driven by an acting force applied from the first brackets 16 to pivotally move upwards relative to the first structural component 11, as shown in FIG. 5.

Accordingly, the moveable frame 10 can be operated to perform a two-stage pivotal movement by the actuation of the actuating device 15. The first stage is to lift the third structural component 13, and the second stage is to lift the second and third structural components 12 and 13 together. However, the third structural component 13 isn't moved relative to the second component 12 in the second stage. Thus, the user's head will be lifted first through the pivotal movement of the third structural component 13, and then the user's back will be lifted later through the pivotal movement of the second structural component 12 so as to enhance the user's comfort.

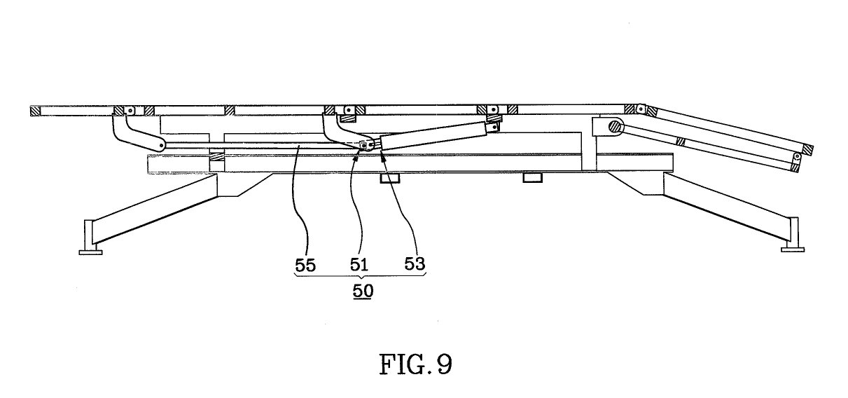

FIG. 9 shows a two-stage actuating device 50 in accordance with a second embodiment of the present invention. In this embodiment, a two-stage actuation means 53 is provided for connecting the first brackets 51 with the retractable rod 54.

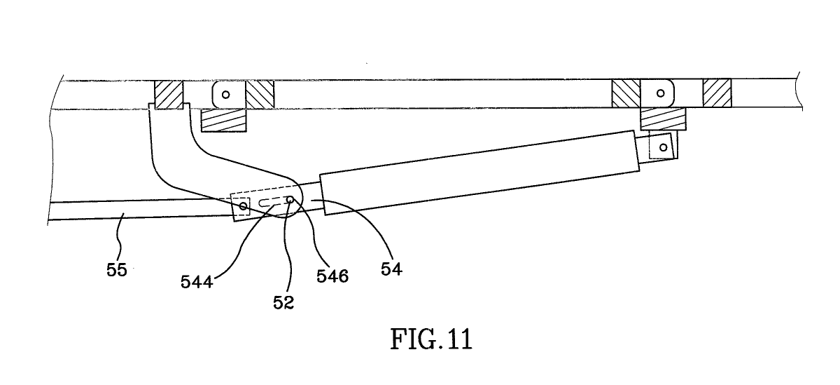

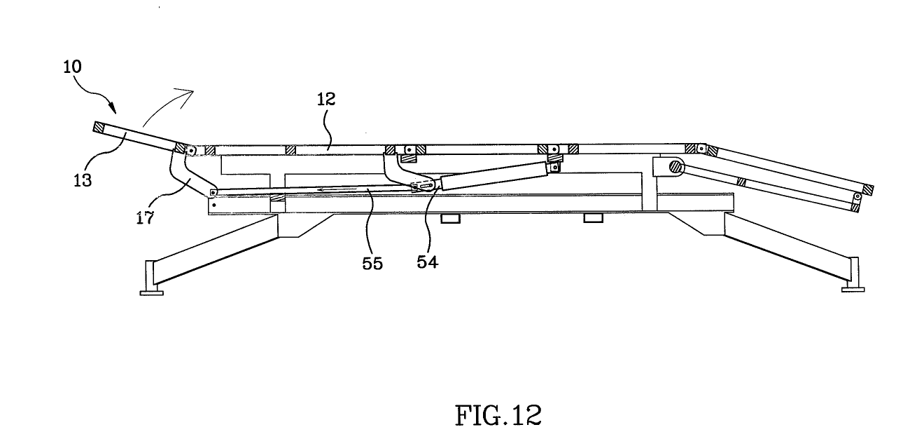

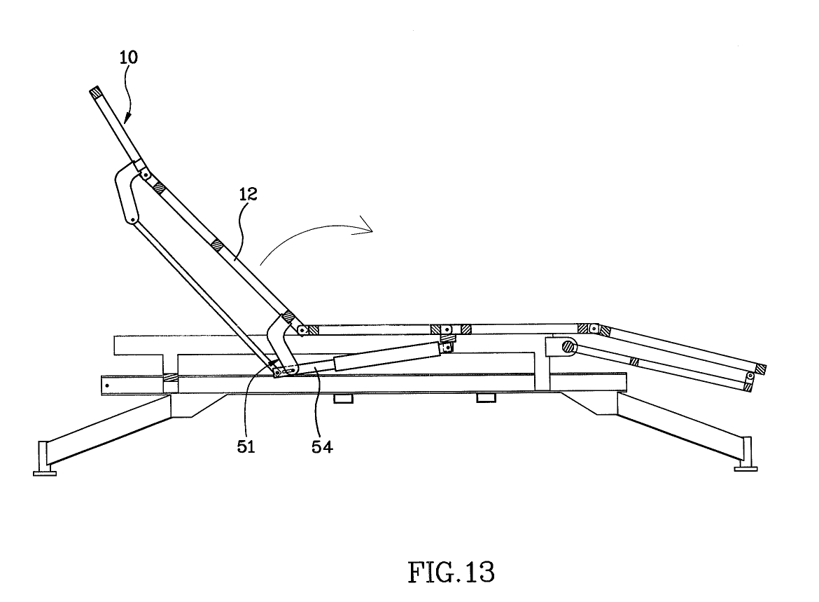

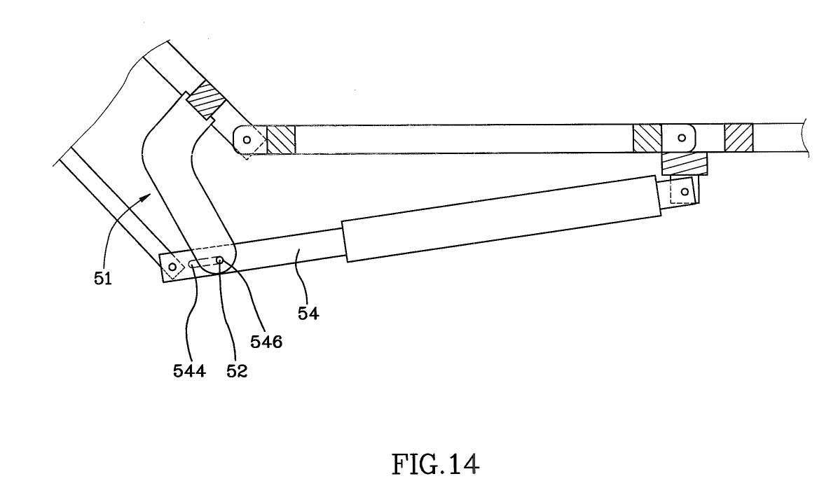

The aforesaid means 53 comprises a sliding slot 544 provided at the retractable rod 54 and a control pin 52 connected between the first brackets 51 and movably inserted into the sliding slot 544. By this way, when the retractable rod 54 extends within the predetermined distance, as shown in FIG. 11, it looks that the sliding slot 544 is moved relative to the control pin 52 such that the control pin 52 is moved towards the rear end 546 of the sliding slot 544, and in this stage, the link rod 55 is driven by the retractable rod 54 to force the second brackets 17 to lift the third structural component 13 of the moveable frame 10, as shown in FIG. 12. In addition, at this stage, the first brackets 51 won't be pushed by the retractable rod 54, and therefore the second structural component 12 is stayed stationarily. When the retractable rod 22 exceeds the predetermined distance, the control pin 52 will be pushed by the rear end 546 of the sliding slot 544 to push the first brackets 51, as shown in FIG. 14. At this stage, the second structural component 12 is driven by an acting force applied from the first brackets 51 to pivotally move upwards relative to the first structural component 11, as shown in FIG. 13. Further, it is to be understood that the two-stage actuating device 50 can provide only one first bracket 51. This way can also achieve the function that two first brackets 51 can provide.

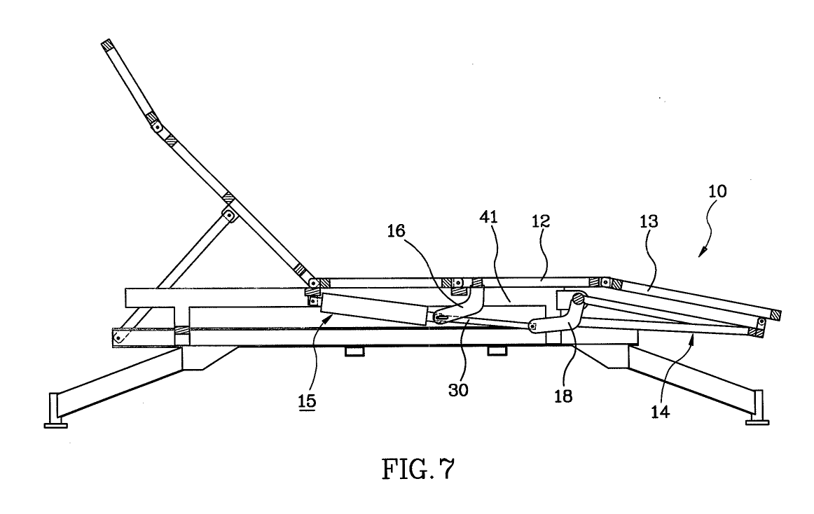

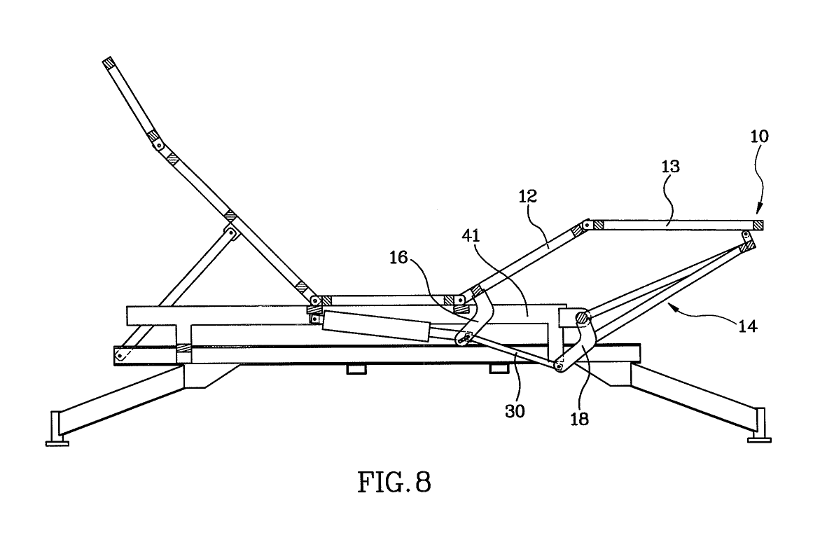

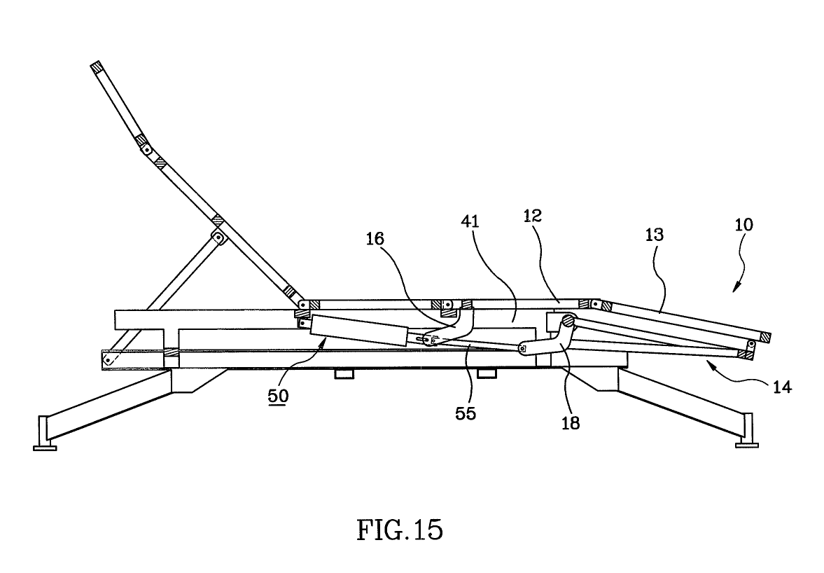

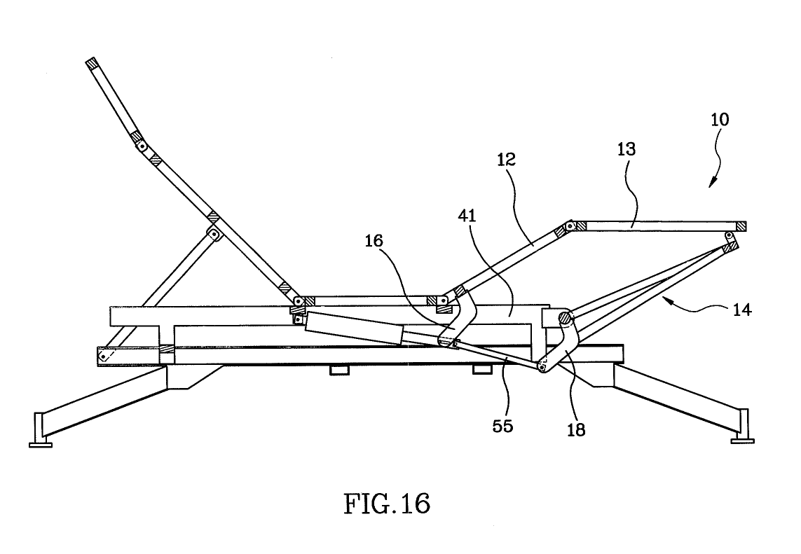

On the other hand, each of the two-stage actuating devices 15 and 50 can be installed in a contrary direction to lift the user's leg. As shown in FIGS. 7, 8, 15 and 16, the moveable frame 10 has two second brackets 18 and a forth structural component 14 pivotally connected with the fixing frame 41. The link rods 30 and 55 each have one end located between the second brackets 18 and pivotally connected with the second brackets 18, such that the second brackets 18 can be pushed by the link rod 30 as shown in FIGS. 7 and 8 or link rod 55 as shown in FIGS. 15 and 16 to pivotally move. The forth structural component 18 has one side connected with the second brackets 18 and the other side abutted against the bottom side of the third structural component 13, such that the forth structural component 18 can be driven by the pivotal movement of the second brackets 18 to lift the third structural component 13. Thus, when the third structural component 13 is pivotally moved by the actuation of the link rod 30 or the link rod 55, the user's lower legs will be lifted through the pivotal movement of the third structural component 13, and then when the first brackets 16 and the second structural component 12 are pushed by the link rod 30 or the link rod 55, the user's thighs will be lifted through the pivotal movement of the second structural component 12, thereby attaining the purpose of enhancing the user's comfort through the two-stage pivotal movement.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A two-stage actuating device for an electric apparatus comprising a fixing frame and a moveable frame pivotally connected with the fixing frame, the two-stage actuating device comprising:
a driver having a cylinder body for being pivotally mounted to the fixing frame, and a retractable rod extending out of the cylinder body;
a link rod having one end pivotally connected with the retractable rod of the driver through a pivot, and the other end for being pivotally connected with the moveable frame;
a bracket having one end for being mounted to the moveable frame; and
two-stage actuating means for connecting the other end of the bracket with the retractable rod of the driver for allowing the bracket not to be driven by the retractable rod and the link rod to be driven by the retractable rod to move to cause a first-stage movement of the moveable frame relative to the fixing frame when the retractable rod extends within a predetermined distance, and allowing the link rod and the bracket to be driven by the retractable rod to move to cause a second-stage movement of the moveable frame relative to the fixing frame when the retractable rod extends exceeding the predetermined distance.

2. The two-stage actuating device as claimed in claim 1, wherein the two-stage actuating means comprises a sliding slot provided at the bracket, and an extending member axially extending from one end of the pivot and movably inserted into the sliding slot.

3. The two-stage actuating device as claimed in claim 2, wherein the bracket comprises an upright portion having a top end for being mounted with the movable frame, and a transverse portion transversely extending from a bottom end of the upright portion and having the sliding slot.

4. The two-stage actuating device as claimed in claim 2, comprising two said brackets between which one end of the link rod is located; the means comprises two said sliding slots respectively provided at the two brackets, and two said extending members respectively extending from two ends of the pivot.

5. The two-stage actuating device as claimed in claim 1, wherein the two-stage actuating means comprises a sliding slot provided at the retractable rod, and a control pin connected with the bracket and movably inserted into the sliding slot.

6. The two-stage actuating device as claimed in claim 5, wherein the bracket comprises an upright portion having a top end for being mounted with the movable frame, and a transverse portion transversely extending from a bottom end of the upright portion for connection of the control pin.

7. The two-stage actuating device as claimed in claim 5, comprising two said brackets between which the control pin is connected.

8. The two-stage actuating device as claimed in claim 1, wherein the link rod has the other end for being pivotally connecting with a bracket of the movable frame.
